(19) United States
(12) Patent Application Publication
(10) Pub. No.: US 2022/0033590 A1
(43) Pub. Date: Feb. 3, 2022

(54) POLYROTAXANE COMPOSITION AND SENSOR

(71) Applicants: TOYODA GOSEI CO., LTD., Kiyosu-shi, Aich-ken (JP); ASM INC., Kashiwashi, Chiba (JP)

(72) Inventors: Yoshinao TAJIMA, Kiyosu-shi, Aichi-ken (JP); Tomoyuki TAINAKA, Kiyosu-shi, Aichi-ken (JP); Takanori NAKAI, Kiyosu-shi, Aichi-ken (JP); Naoto MATSUNAGA, Kiyosu-shi, Aichi-ken (JP); Katsunari INOUE, Kashiwashi, Chiba (JP)

(21) Appl. No.: 17/278,818

(22) PCT Filed: Jul. 4, 2019
(86) PCT No.: PCT/JP2019/026585

§ 371 Date: Mar. 23, 2021

(30) Foreign Application Priority Data
Sep. 29, 2018 (JP) 2018-186214

(51) Int. Cl. C08G 83/00; C08J 5/18; G01L 1/14

(52) U.S. Cl. CPC C08G 83/007; C08J 2353/00; G01L 1/142; C08J 5/18

(57) ABSTRACT

The present invention provides a sensor that exhibits a small effect on a detection target during detection, a high detection sensitivity, a wide dynamic range for detection, and a small change after repeated detection, as well as a composition suitable for use in the sensor.

The composition is a polyrotaxane composition containing two polyrotaxane cyclic molecules crosslinked with a crosslinking agent present between the molecules, wherein the polyrotaxane composition exhibits a hysteresis loss of 10% or less, an elongation at break of 200% or more, an initial Young's modulus of 5 MPa or less, and a relative dielectric constant of 8.0 or more. The sensor includes a film formed of the aforementioned polyrotaxane composition, and elastomer-made electrode layers disposed on both surfaces of the film.

### TECHNICAL FIELD

The present invention relates to a polyrotaxane composition and a sensor formed of the composition.

### BACKGROUND ART

A polyrotaxane is a molecular assembly having a structure wherein a linear molecule slidably penetrates through a cyclic molecule, and the cyclic molecule is prevented from being removed by blocking groups disposed at both ends of the linear molecule (Patent Document 1). A composition containing a polyrotaxane is expected to be used in various applications because of the viscoelasticity of the composition.

Patent Document 2 describes, for example, an actuator including a dielectric layer containing a polyrotaxane and electrodes disposed on both surfaces of the dielectric layer, wherein the dielectric layer undergoes elastic deformation through application of a voltage, as well as a capacitive sensor including a dielectric layer containing a polyrotaxane and electrodes disposed on both surfaces of the dielectric layer, wherein the sensor is adapted to detect the movement of a detection target by a change in capacitance between the electrodes resulting from the elastic deformation of the dielectric layer.

In particular, application of a polyrotaxane to a sensor requires many properties, including a small effect on a detection target during detection (i.e., small reaction force), a high detection sensitivity (i.e., ability to detect a minimal change), a wide dynamic range for detection (i.e., ability to detect even a large change), and a small change after repeated detection (i.e., low hysteresis loss).

Patent Documents 3 and 4 disclose an example of a crosslinked product formed of a specific photocrosslinkable polyrotaxane and exhibiting a low hysteresis loss of 5 to 23%.

Patent Document 5 discloses an example of a crosslinked product formed of a crosslinked polyrotaxane prepared by crosslinking of two polyrotaxane cyclic molecules with a polymer present therebetween, wherein the crosslinked product exhibits a low hysteresis loss of 1.6 to 13.5%. The patent document exemplifies, as the polymer, many products such as polyethylene glycol diol, polypropylene diol, and polytetrahydrofuran. Crosslinking agents used in the aforementioned example are a crosslinking agent containing a polycarbonate diol having both ends modified with an isocyanate group and 1,3-bis(isocyanatomethyl)cyclohexane, and a crosslinking agent containing a polycarbonate having at its both ends isocyanate groups protected with ε-caprolactam.

### PRIOR ART DOCUMENTS

### Patent Documents

Patent Document 1: WO 2005/080469
Patent Document 2: Japanese Unexamined Patent Application Publication No. 2014-118481 (JP 2014-118481 A)
Patent Document 3: WO 2011/105532
Patent Document 4: Japanese Patent No. 5833199 (JP 5833199 B)
Patent Document 5: Japanese Unexamined Patent Application Publication No. 2011-241401 (JP 2011-241401 A)

### SUMMARY OF THE INVENTION

### Problems to be Solved by the Invention

However, application of the polyrotaxanes disclosed in Patent Documents 3 to 5 to a sensor leaves room for improvement in the balance between dielectric constant, Young's modulus, and elongation at break. Specifically, low Young's modulus is required for reducing the effect on a detection target during detection; low Young's modulus and high dielectric constant are required for increasing detection sensitivity; and high elongation at break is required for increasing dynamic range. In particular, the polyrotaxanes disclosed in Patent Documents 3 to 5 leave room for improvement in elongation at break.

In view of the foregoing, an object of the present invention is to provide a sensor that exhibits a small effect on a detection target during detection, a high detection sensitivity, a wide dynamic range for detection, and a small change after repeated detection, as well as a composition suitable for use in the sensor.

### Means for Solving the Problems

The present inventors have conducted studies on crosslinking agents, and have found that elongation at break can be particularly improved. The present invention described below has been accomplished on the basis of this finding.

[1] Polyrotaxane Composition of the Invention

The present invention is directed to a polyrotaxane composition containing two polyrotaxane cyclic molecules crosslinked with a crosslinking agent present between the molecules, characterized in that the polyrotaxane composition exhibits a hysteresis loss of 10% or less, an elongation at break of 200% or more, an initial Young's modulus of 5 MPa or less, and a relative dielectric constant of 8.0 or more.

(Effects)

According to the present invention, the effect on a detection target during detection can be reduced, since the Young's modulus is 5 MPa or less. Also, detection sensitivity can be increased, since the Young's modulus is 5 MPa or less, and the relative dielectric constant is 8.0 or more. Also, dynamic range can be increased, since the elongation at break is 200% or more. Also, a change after repeated detection can be reduced, since the hysteresis loss is 10% or less.

Preferably, the crosslinking agent is a polymer having no side chain, having a number average molecular weight of 500 or more, and having functional groups at both ends of the polymer, and the functional groups are directly or indirectly bonded to the polyrotaxane cyclic molecules. This is for the following reason: the use of a polymer having a number average molecular weight of 500 or more probably leads to an increase in elongation at break and a decrease in Young's modulus.

The polymer is preferably polyether or polyester.

The polymer is more preferably polytetramethylene ether glycol.

The lower limit of the hysteresis loss is not particularly determined, but is probably 0%.

The upper limit of the elongation at break is not particularly determined, but is probably 2,000%.

The lower limit of the Young's modulus is not particularly determined, but is probably 0.1 MPa.

The upper limit of the relative dielectric constant is not particularly determined, but is probably 50.

[2] Sensor of the Invention

The present invention is also directed to a sensor including a film formed of the aforementioned polyrotaxane composition, and elastomer-made electrode layers disposed on both surfaces of the film.

Preferably, a hysteresis loss of a change in capacitance is 0.5% or less during expansion and contraction of the sensor.

No particular limitation is imposed on the elastomer-made electrode layer, but the elastomer-made electrode layer may be, for example, an electrode layer formed of an elastomer (e.g., silicone, natural rubber, urethane rubber, or crosslinked polyrotaxane) containing electrically conductive particles of, for example, platinum, carbon, or silver. No particular limitation is imposed on the method for forming the elastomer-made electrode layer. For example, the electrode layer can be formed by application of an elastomer liquid containing the aforementioned electrically conductive particles dispersed therein, and curing of the applied elastomer liquid.

No particular limitation is imposed on the thickness of the film, but the thickness is preferably 0.025 to 0.5 mm. A thickness of less than 0.025 mm leads to a high likelihood of breakage of the film, resulting in poor handling property during production of the sensor. Meanwhile, a thickness of more than 0.5 mm leads to a reduction in detection resolution, or an increase in load on a measurement target due to an increase in tensile stress.

### Effects of the Invention

The present invention can provide a sensor that exhibits a small effect on a detection target during detection, a high detection sensitivity, a wide dynamic range for detection, and a small change after repeated detection, as well as a composition suitable for use in the sensor.

### BRIEF DESCRIPTION OF THE DRAWINGS

FIG. 1 is a schematic view showing the structures of polyrotaxane (A) and polymers (B1), (B1′), and (B2) prepared in Example and Comparative Example;

FIG. 2 is a schematic view showing the structures of films of Example and Comparative Example;

FIG. 3 is an explanatory view showing a dielectric breakdown test performed on the compound film; and

FIG. 4 is a perspective view showing a sensor of Example and Comparative Example.

### MODES FOR CARRYING OUT THE INVENTION

(A) Polyrotaxane

Examples of the cyclic molecule include, but are not particularly limited to, cyclodextrin, crown ether, cyclophane, calixarene, cucurbituril, and cyclic amide. The cyclic molecule is preferably cyclodextrin, and particularly preferably selected from α-cyclodextrin, β-cyclodextrin, and γ-cyclodextrin. The cyclic molecule may contain cyclodextrin and another cyclic molecule. Some of hydroxyl groups of cyclodextrin may be substituted by another group, such as —SH, —NH₂, —COOH, —SO₃H, or —POOH, or may be substituted by a substituent having a graft chain (e.g., a graft chain formed through ring-opening polymerization of a lactone monomer) so as to be solubilized in various organic solvents. The most preferred cyclic molecule may be cyclodextrin having polycaprolactone as a graft chain having 20 or more chains.

Examples of the linear molecule include, but are not particularly limited to, polyethylene glycol, polylactic acid, polyisoprene, polyisobutylene, polybutadiene, polypropylene glycol, polytetrahydrofuran, polydimethylsiloxane, polyethylene, polypropylene, polyvinyl alcohol, and polyvinyl methyl ether. The linear molecule is preferably polyethylene glycol, and may contain polyethylene glycol and another linear molecule.

Examples of the blocking group include, but are not particularly limited to, dinitrophenyl group, cyclodextrin group, adamantane group, trityl group, fluorescein group, pyrene group, substituted benzene group (the substituent may be, for example, alkyl, alkyloxy, hydroxy, halogen, cyano, sulfonyl, carboxyl, amino, or phenyl; one or more substituents may be present), optionally substituted polynuclear aromatic group (the substituent may be, for example, the same as those described above; one or more substituents may be present), and steroid group. The blocking group is preferably selected from the group consisting of dinitrophenyl group, cyclodextrin group, adamantane group, trityl group, fluorescein group, and pyrene group, and is more preferably adamantane group or trityl group.

(B) Polymer Having No Side Chain

Examples of the polymer having no side chain include, but are not particularly limited to, polyether, polyester, polyamide, polyurethane, polyethylene, and a copolymer of any of these, and a mixture of any of these. As described above, the polymer having no side chain is preferably polyether or polyester, more preferably polytetramethylene ether glycol.

(C) Sensor

The sensor is a capacitive sensor. Examples of the form of the sensor include, but are not particularly limited to, a tensile sensor and a compression sensor (including a pressure-sensitive sensor).

### EXAMPLES

Embodiments of the present invention; i.e., examples of the polyrotaxane composition and sensor of the invention will be described in the following order. The present invention should not be construed as being limited to the examples.

### <1> Preparation of Polyrotaxane (A)

### <2> Preparation of Polymer

### <2-1> Preparation of Polymer (B1)

### <2-2> Preparation of Polymer (B1′)

### <2-3> Preparation of Polymer (B2)

### <3> Diol

### <3-1> Diol (C1)

### <3-2> Diol (C2)

### <4> Preparation of Composition Solution

### <5> Formation of Film

### <6> Measurement of Physical Properties of Film

### <7> Production of Sensor

### <8> Measurement of Performance of Sensor

Preparation of Polyrotaxane (A)

Firstly, the hydroxypropyl-group-modified polyrotaxane (hereinafter may be abbreviated as “HAPR”) disclosed in WO 2005/080469 (Patent Document 1) was prepared as a polyrotaxane containing cyclodextrin as a cyclic molecule, polyethylene glycol as a linear molecule, and blocking groups disposed at both ends of the linear molecule.

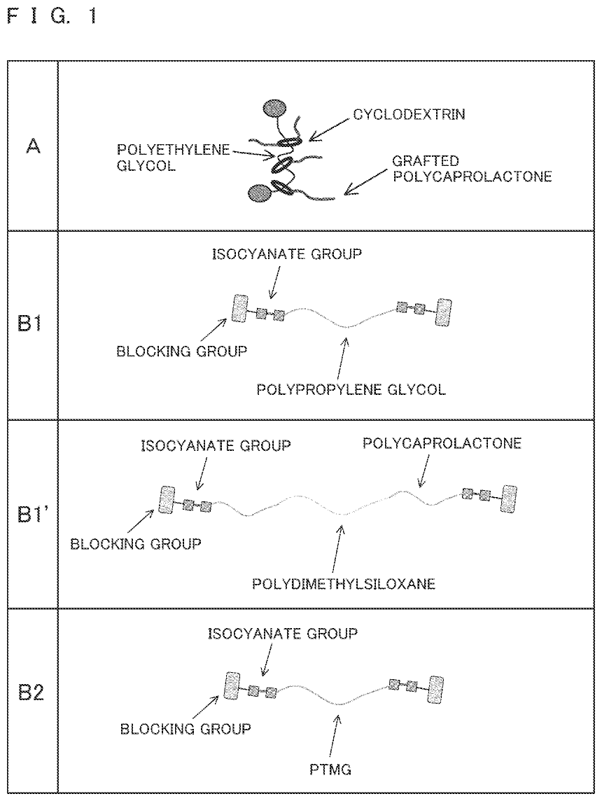

Subsequently, a polyrotaxane having a caprolactone group was prepared by the method described below so as to achieve solubility and compatibility. A three-necked flask was charged with 10 g of the aforementioned HAPR, and 45 g of ε-caprolactone was added to the flask under a slow stream of nitrogen. The resultant mixture was homogeneously stirred with a mechanical stirrer at 100° C. for 30 minutes, and then the reaction temperature was increased to 130° C. Subsequently, 1.6 g of tin 2-ethylhexanoate previously diluted with toluene (50 wt % solution) was added to the mixture, and reaction was allowed to proceed for five hours, followed by removal of the solvent, to thereby prepare 55 g of polyrotaxane (A) having a caprolactone group (hereinafter may be abbreviated as “HAPR-g-PCL”). The structure of polyrotaxane (A) is shown in the first row of FIG. 1. The cyclic molecule has polycaprolactone (having about 35 chains) as a graft chain. Polyrotaxane (A) was found to have a weight average molecular weight Mw of 580,000 and a molecular weight distribution Mw/Mn of 1.5 by GPC.

<2> Preparation of Polymer

The following three polymers were prepared.

<2-1> Preparation of Polymer (B1)

A three-necked eggplant flask was charged with 91.57 g of TAKENATE 600 (available from Mitsui Chemicals, Incorporated), followed by stirring in an oil bath at 80° C. under a stream of nitrogen. Subsequently, 110 g of Polypropylene glycol 700 (diol type, available from Wako Pure Chemical Industries, Ltd.) was slowly added dropwise to the solution in the flask over two hours, and then the resultant mixture was further stirred for two hours. After completion of the reaction, the liquid temperature was decreased to room temperature, and then 76.58 g of 2-butanone oxime was slowly added dropwise to the reaction mixture so that the liquid temperature did not reach 60° C. or higher. After completion of the dropwise addition, the resultant mixture was further stirred at room temperature for eight hours, to thereby prepare a crosslinking agent solution containing polypropylene glycol (PPG) (B1) having end-blocked isocyanate groups. The structure of polymer (B1) is shown in the second row of FIG. 1.

<2-2> Preparation of Polymer (B1′)

A three-necked eggplant flask was charged with 100 g of Polydimethylsiloxane X-22-160AS having both ends modified with carbinol (available from Shin-Etsu Chemical Co., Ltd.) and 200 g of ε-caprolactone (available from Daicel Corporation), and then the mixture was stirred in an oil bath at 110° C. under a stream of nitrogen for two hours for dehydration. The temperature of the oil bath was increased to 130° C., and then 0.1 g of tin 2-ethylhexanoate (available from Aldrich) was added to the mixture, followed by stirring for six hours. The temperature was decreased to 50° C., and then 300 g of toluene (available from Kanto Chemical Co., Inc.) was added to the mixture, to thereby prepare a solution of polydimethylsiloxane having both ends grafted with polycaprolactone.

Another three-necked eggplant flask was charged with 41.68 g of TAKENATE 600 (available from Mitsui Chemicals, Incorporated), followed by stirring in an oil bath at 90° C. under a stream of nitrogen. Subsequently, 400 g of the aforementioned solution of polydimethylsiloxane having both ends grafted with polycaprolactone was slowly added dropwise to the solution in the flask over two hours, and then the resultant mixture was further stirred for two hours. After completion of the reaction, the liquid temperature was decreased to room temperature, and then 25.9 g of 2-butanone oxime (available from Tokyo Chemical Industry Co., Ltd.) was slowly added dropwise to the reaction mixture so that the liquid temperature did not reach 60° C. or higher. After completion of the dropwise addition, the resultant mixture was stirred at room temperature for five hours, to thereby prepare a crosslinking agent solution containing polydimethylsiloxane (PDMS) (B1′) having end-blocked isocyanate groups. The structure of polymer (B1′) is shown in the third row of FIG. 1.

<2-3> Preparation of Polymer (B2)

A three-necked eggplant flask was charged with 378.0 g of TAKENATE 600 (available from Mitsui Chemicals, Incorporated), followed by stirring in an oil bath at 90° C. under a stream of nitrogen. Subsequently, 550 g of Polytetramethylene oxide 650 (available from Wako Pure Chemical Industries, Ltd.) was slowly added dropwise to the solution in the flask over two hours, and then the resultant mixture was further stirred for two hours. After completion of the reaction, the liquid temperature was decreased to 40° C., and then 210.9 g of 2-butanone oxime (available from Tokyo Chemical Industry Co., Ltd.) was slowly added dropwise to the reaction mixture so that the liquid temperature did not reach 60° C. or higher. After completion of the dropwise addition, the resultant mixture was stirred at 40° C. for five hours, to thereby prepare a crosslinking agent containing polytetramethylene oxide (PTMG) (B2) having end-blocked isocyanate groups. The structure of polymer (B2) is shown in the fourth row of FIG. 1.

<3> Diol

The following two polymers were used.

### <3-1> Diol (C1)

Polypropylene glycol 700 (diol type, available from Wako Pure Chemical Industries, Ltd.) was used as is.

### <3-2> Diol (C2)

Polytetramethylene oxide 650 (available from Wako Pure Chemical Industries, Ltd.) was used as is.

<4> Preparation of Composition Solution

The products prepared in (A) to (C*) above were selectively used in amounts (represented by “parts by mass”) shown in Table 1 below, to thereby prepare composition solutions of Example and Comparative Example.

TABLE 1

| | Comparative | |
|---|---|---|
| | Example | Example |
| Components of Composition | | |
| Polyrotaxane (A) | 16.1 | 13 |
| Polymer (B1) (PPG) | 14.47 | — |
| Polymer (B1′) (PDMS) | 17.11 | — |
| Polymer (B2) (PTMG) | — | 26.99 |
| Diol (C1) | 7.53 | — |
| Diol (C2) | — | 11.29 |
| Deprotection Catalyst | 0.8 | 0.8 |
| Silicon Additive | 0.8 | 0.8 |
| Hydrolysis Inhibitor | 1.6 | 1.7 |
| Antioxidant | 0.97 | 1.03 |
| Physical Properties of Film | | |
| Elongation at Break (%) | 146 | 242 |
| Initial Young's Modulus (Mpa) | 3.3 | 3.4 |
| Relative Dielectric Constant | 8 | 9 |
| Dielectric Breakdown Strength (V/μm) | 93 | 99 |
| Hysteresis Loss (%) | 1 | 2 |
| Performance of Sensor | | |
| Hysteresis Loss of Capacitance (%) | — | 0.1 |

The deprotection catalyst used was dibutyltin dilaurate. The silicon additive used was “DBL-C31” (both-end alcohol-modified silicone:

caprolactone-dimethylsiloxane-caprolactone block copolymer) available from GELEST.

The hydrolysis inhibitor used was “CARBODILITE V-09 GB” available from Nisshinbo Chemical Inc.

The antioxidant used was “IRGANOX 1726” (2,4-bis(dodecylthiomethyl)-6-methylphenol) available from BASF.

The prepared products (A) to (C*) shown in Table 1 above were dissolved in a solvent (methyl cellosolve for Comparative Example, toluene for Example) and stirred to thereby prepare a homogeneous solution. The aforementioned dibutyltin dilaurate, DBL-C31, IRGANOX 1726, and CARBODILITE V-09 GB were added to the solution and then stirred to thereby prepare homogeneous composition solutions of Example and Comparative Example.

<5> Formation of Film

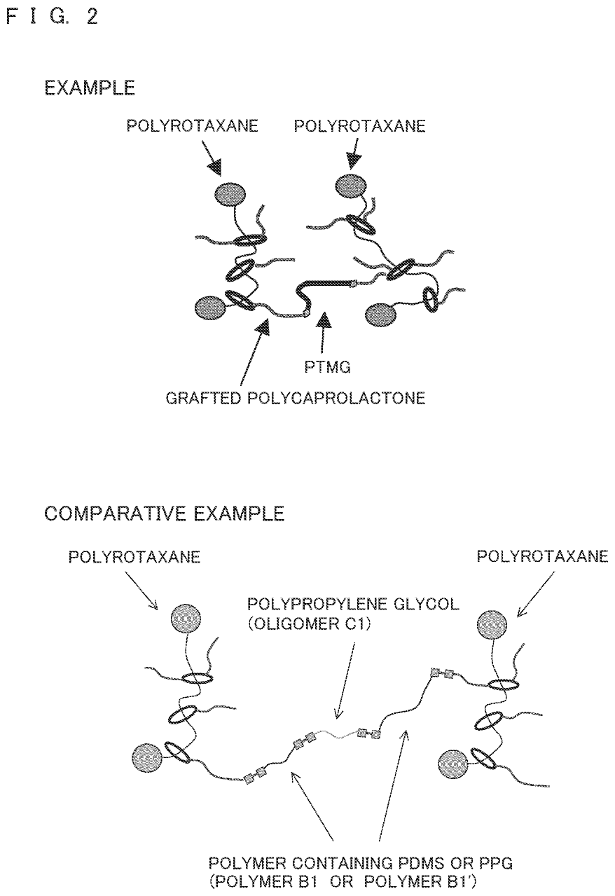

Each of the composition solutions of Example and Comparative Example prepared in <4> above was thoroughly defoamed and then applied to a PET sheet by slit die coating. Thereafter, the composition solution was cured in an oven at 130° C. under reduced pressure for five hours, and then the cured product was removed from the PET sheet, to thereby form a film having a thickness of 0.05 mm. The film exhibited stretchability (i.e., capable of undergoing elastic deformation). FIG. 2 schematically shows the structures of the films of Example and Comparative Example.

<6> Measurement of Physical Properties of Film

The physical properties of the films of Example and Comparative Example were measured as described below. The results are shown in Table 1.

<6-1> Elongation at Break and (Initial) Young's Modulus

Each film was processed into a shape of dumbbell No. 7 to thereby prepare a measurement sample. The sample was subjected to a tensile test with a tensile tester available from SHIMADZU CORPORATION (distance between grabbers: 20 mm, tensile speed: 100 mm/minute), to thereby record a stress-strain curve. The elongation at break was measured from the distance between the grabbers at the time of breakage of the sample. The initial elastic modulus was calculated from a slope of the linear approximation of stress-strain curves at 1 to 5% elongation.

<6-2> Relative Dielectric Constant

Platinum (ϕ inner diameter: 5 mm) was vapor-deposited on each sample with an auto fine coater (JEC-3000FC, available from JEOL Ltd.), and the capacitance was measured with Pecision Impedance Analyser (4294A, available from Agilent) by using a dielectric constant measuring probe, to thereby calculate a relative dielectric constant.

<6-3> Dielectric Breakdown Strength

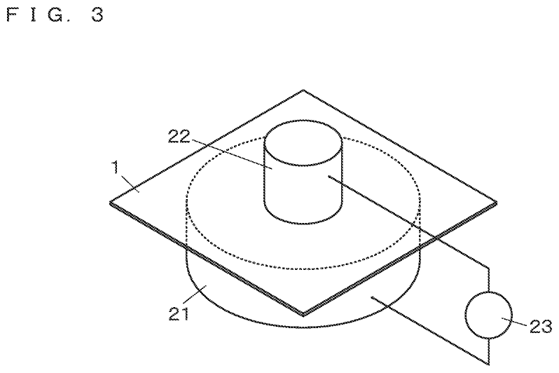

As shown in FIG. 3, a film 1 was attached to a disk electrode 21 on a set side, and a cylindrical electrode 22 was placed on the film 1 so that the amount of air bubbles remaining between the film 1 and the electrodes 21 and 22 was reduced to a minimum possible level, followed by deaeration treatment with a vacuum apparatus. This assembly was set in a dielectric breakdown measurement device at ambient temperature and ambient humidity, and voltage was applied between the electrodes 21 and 22 with a power supply 23 such that a voltage-increasing rate of 10 V/0.1 seconds is achieved. The dielectric breakdown field strength (V/μm) was determined from the voltage at the time when the current was 1.2 μA or more after an insulating state (i.e., substantially no flow of current). The term “ambient temperature” refers to 20±15° C., and the term “ambient humidity” refers to 65±20% (cf. JIS-8703, the same shall apply herein).

<6-3> Hysteresis Loss

Similar to the case of Patent Document 5, the term “hysteresis loss” refers to the mechanical energy loss rate (hysteresis loss) determined according to JIS K6400 in one cycle of deformation and recovery of a material (wherein deformation of the material is replaced with a strain obtained by a tensile test of the material).

Specifically, a sample having a shape of dumbbell No. 7 (according to JIS K-6251) is subjected to a tensile test to thereby determine a stress-strain curve. After being expanded to 100% of the effective length, the sample is contracted to 0% at a speed equal to the expansion speed. This cycle was performed 10 times, and the hysteresis loss was calculated by the method for measuring and calculating an area described in Patent Document 5.

<7> Production of Sensor

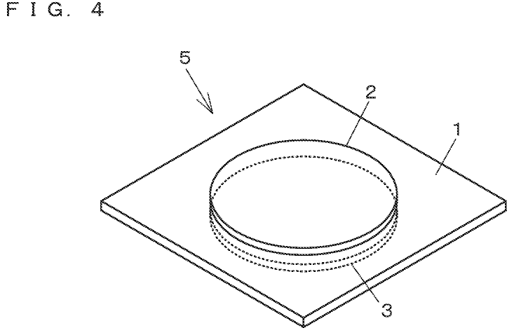

Both surfaces of a film were covered with masks each having an opening (ϕ: 20 mm), and a coating liquid containing 20 g of a silicon-made electrode material (a solution of silicon rubber in an organic solvent containing carbon particles dispersed therein) and 0.6 g of a catalyst was applied with a spray gun to portions of the film exposed through the mask openings. Thereafter, the applied coating liquid was cured through crosslinking, to thereby produce, as shown in FIG. 4, a sensor 5 including a film 1 and electrode layers (ϕ: 20 mm) 2 and 3 disposed on both surfaces of the film 1. The electrode layers 2 and 3 and the film exhibit stretchability (i.e., capable of being expanded and contracted).

<8> Measurement of Performance of Sensor

The opening of the aforementioned electrode-forming mask was changed into an opening having dimensions of 10 mm×30 mm, and the resultant sensor was cut into a rectangular test piece having dimensions of 20 mm×40 mm so that the formed electrodes were located at the center of the test piece. While AC voltage was applied between the electrodes of the test piece via cables connected to the electrodes, the tensile test according to JIS K6400 was performed.

Specifically, the test piece is subjected to the tensile test with a tensile tester (distance between grabbers: 30 mm, tensile speed: 100 mm/minute), to thereby measure a capacitance-strain curve until 100% elongation of the test piece. Thereafter, while the test piece is contracted to 0% at the same speed as described above, a capacitance-strain curve is measured. This cycle was performed 10 times, and the hysteresis loss of capacitance was calculated as the average of the values obtained at the second to tenth cycles by the method for measuring and calculating an area described in Patent Document 5. The results are shown in Table 1.

The present invention is not limited to the aforementioned examples, and may be appropriately modified and embodied without departing from the spirit of the invention.

### DESCRIPTION OF THE REFERENCE NUMERALS

1: Film
2: Electrode layer
3: Electrode layer
5: Sensor
21: Disk electrode
22: Cylindrical electrode
23: Powder supply

1. A polyrotaxane composition comprising two polyrotaxane cyclic molecules crosslinked with a crosslinking agent present between the molecules, wherein the polyrotaxane composition exhibits a hysteresis loss as a mechanical energy loss rate of 10% or less, an elongation at break of 200% or more, an initial Young's modulus of 5 MPa or less, and a relative dielectric constant of 8.0 or more.

2. The polyrotaxane composition according to claim 1, wherein the crosslinking agent is a polymer having no side chain, having a number average molecular weight of 500 or more, and having functional groups at both ends of the polymer, and the functional groups are directly or indirectly bonded to the polyrotaxane cyclic molecules.

3. The polyrotaxane composition according to claim 2, wherein the polymer is polyether or polyester.

4. The polyrotaxane composition according to claim 3, wherein the polymer is polytetramethylene ether glycol.

5. A sensor comprising a film formed of the polyrotaxane composition according to claim 1, and elastomer-made electrode layers disposed on both surfaces of the film.

6. The sensor according to claim 5, wherein a hysteresis loss of a change in capacitance is 0.5% or less during expansion and contraction of the sensor.
